(19) United States
(12) Patent Application Publication
(10) Pub. No.: US 2026/0126406 A1
(43) Pub. Date: May 7, 2026

(54) CHARACTERISATION OF ELECTROCHEMICAL CELLS

(71) Applicant: Cirrus Logic International Semiconductor Ltd., Edinburgh (GB)

(72) Inventors: John P. LESSO, Edinburgh (GB); Claire MOTION, Edinburgh (GB)

(73) Assignee: Cirrus Logic International Semiconductor Ltd., Edinburgh (GB)

(21) Appl. No.: 18/937,349

(22) Filed: Nov. 5, 2024

(51) Int. Cl. G01N 27/04; G01N 27/333

(52) U.S. Cl. CPC G01N 27/045; G01N 27/333

(57) ABSTRACT

Circuitry for determining a characteristic of an electrochemical cell having a first electrode and a second electrode, the circuitry comprising: measurement circuitry configured to measure a sense current derived from the first electrode and output a sense signal at an output of the measurement circuitry based on the measured sense current; a filter configured to filter the sense signal to obtain a filtered sense signal; and processing circuitry configured to: estimate a signal noise level in the filtered sense signal; and determine the characteristic of the electrochemical cell based on the signal noise level.

### TECHNICAL FIELD

The present disclosure relates to circuitry and methods for measuring characteristics in electrochemical cells.

### BACKGROUND

Electrochemical sensors are widely used for the detection or characterisation of one or more particular chemical species, analytes, typically as an oxidation or reduction current. Such sensors comprise an electrochemical cell, consisting of two or more electrodes configured for contact with an analyte whose concentration is to be ascertained.

For potentiometric measurement typically used for characterisation of ion-selective electrode (ISE) sensors, a potential difference is measured between an electrode and an analyte with no external bias and with no current flow. A working electrode (indicator electrode) of the electrochemical cell can be used as a proxy for the electrode, and a reference electrode can be used as a proxy for the analyte. Thus, the potential difference between the working electrode and the reference electrode gives an indication of a property of the electrode and the analyte.

### SUMMARY

According to a first aspect of the disclosure, there is Circuitry for determining a characteristic of an electrochemical cell having a first electrode and a second electrode, the circuitry comprising: measurement circuitry configured to measure a cell signal derived from the first electrode and output a sense signal at an output of the measurement circuitry based on the measured cell signal; a filter configured to filter the sense signal to obtain a filtered sense signal; and processing circuitry configured to: estimate a signal noise level in the filtered sense signal; and determine the characteristic of the electrochemical cell based on the signal noise level.

Estimating the signal noise level may comprise determining a standard deviation or variance of the filtered sense signal, and determining a mean of the filtered sense signal.

The standard deviation or variance may be determined using a Student's algorithm.

The mean and variance may be determined using an online algorithm, such as Welford's algorithm.

Estimating the signal noise level may comprise one or more of: determining a median of the filtered sense signal; determining one or more percentiles of the filtered sense signal; and determining an interquartile range based on the median and the one or more percentiles.

Estimating the signal noise level may comprise: determining a signal to noise ratio (SNR) of the filtered sense signal.

The processing circuitry may comprise an analog-to-digital converter, ADC, configured to output a digital sense signal based on the filtered sense signal. The signal noise level may be estimated based on the digital sense signal.

The filter may be configured to pass one or more frequencies of interest of the sense signal at which variation in noise with varying analyte concentration in the electrochemical cell is maximised.

The first electrode may be an ion selective electrode. The filter may be configured to pass one or more frequencies of interest at which a behaviour of the electrochemical cell is substantially dominated by the ion-selective electrode.

The filter may comprise a bandpass filter centred on the one or more frequencies of interest.

The filter may comprise a lowpass filter having a cutoff frequency at or above the one or more frequencies of interest.

The characteristics may comprise one or more of: an impedance; and an analyte concentration or an analyte.

The processing circuitry may be configured to determine the analyte concentration based on the impedance.

The analyte concentration C may be determined from the impedance R based on the following equation:

$$R ( C ) \approx \frac{k}{{Λ}_{M}^{∘} C - α {C}^{\frac{3}{2}}}$$

where Λ°_{M} is the molar conductivity at infinite dilution, and a is the dissociation degree of the analyte in the cell.

The measurement circuitry may comprise a transimpedance amplifier, TIA. The TIA may comprise: an op-amp comprising an inverting input configured to receive the cell signal, a non-inverting input coupled to a first reference voltage, the output of the measurement circuit comprising an output of the op-amp; and a feedback impedance coupled between the output and the first input. The circuitry may further comprise an input impedance coupled between the inverting input and a second reference voltage.

The measurement circuitry may comprise a current conveyor, CC, comprising an X input and a Y input, wherein the X input of the CC is configured to receive the cell signal, wherein the output of the measurement circuitry is a Z output of the CC.

The measurement circuitry may comprise an op-amp comprising an inverting input configured to receive the cell signal, a non-inverting input, and an output, the output coupled to the non-inverting input. The circuitry may further comprise an input impedance coupled between the non-inverting input and a reference voltage.

The first electrode or the second electrode may comprise an ion-selective electrode.

The sense signal may comprise a sense voltage or a sense current.

According to another aspect of the disclosure, there is provided an electrochemical sensor, comprising: circuitry as described above; and the electrochemical cell.

The first electrode may be a working electrode, and the second electrode may be a reference electrode. Alternatively, the first electrode may be an anode, and the second electrode may be a cathode.

According to another aspect of the disclosure, there is provided a multi-analyte sensor, comprising: circuitry as described above; and the electrochemical cell. The first electrode may be a first ion selective electrode, the second electrode may be a reference electrode, and the electrochemical cell may further comprise a second ion selective electrode.

According to another aspect of the disclosure, there is provided an electronic device, comprising circuitry as described above or a sensor as described above.

The electronic device may comprise one of an analyte monitoring device or an analyte sensing device, a battery, a battery monitoring device, a mobile computing device, a laptop computer, a tablet computer, a games console, a remote control device, a home automation controller or a domestic appliance, a toy, a robot, an audio player, a video player, or a mobile telephone, and a smartphone.

According to another aspect of the disclosure, there is provided a method of determining a characteristic of an electrochemical cell having a first electrode and a second electrode, the method comprising: measuring a cell signal derived from the first electrode and output a sense signal at an output of the measurement circuitry based on the measured cell signal; filtering the sense signal to obtain a filtered sense signal; estimate a signal noise level in the filtered sense signal; and determine the characteristic of the electrochemical cell based on the signal noise level.

Throughout this specification the word “comprises”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 illustrates a schematic symbol and diagram of an electrochemical cell comprising an ion-selective electrode;

FIG. 2 is a schematic diagram of a known measurement circuit;

FIG. 3 is a graphical illustration of ion concentration vs signal to noise ratio for an electrochemical cell;

FIG. 4 is a graphical illustration of ion concentration vs signal noise for an electrochemical cell;

FIG. 5 is a schematic diagram circuitry for determining a characteristic of an electrochemical cell;

FIG. 6 is a schematic diagram of an example implementation of an ion-sensor and measurement circuitry of FIG. 5; and

FIG. 7 is a schematic diagram of an example multi-electrode sensor and processing circuitry.

### DESCRIPTION OF EMBODIMENTS

Embodiments of the present disclosure relate to the measurement of signals (such as analyte signals) in electrochemical cells comprising an ion-selective electrode (ISE). In particular, embodiments relate to measuring noise in such electrochemical cells and using such measurements to determine an impedance and/or analyte concentration of a respective cell by providing a capacitor in series with the cell.

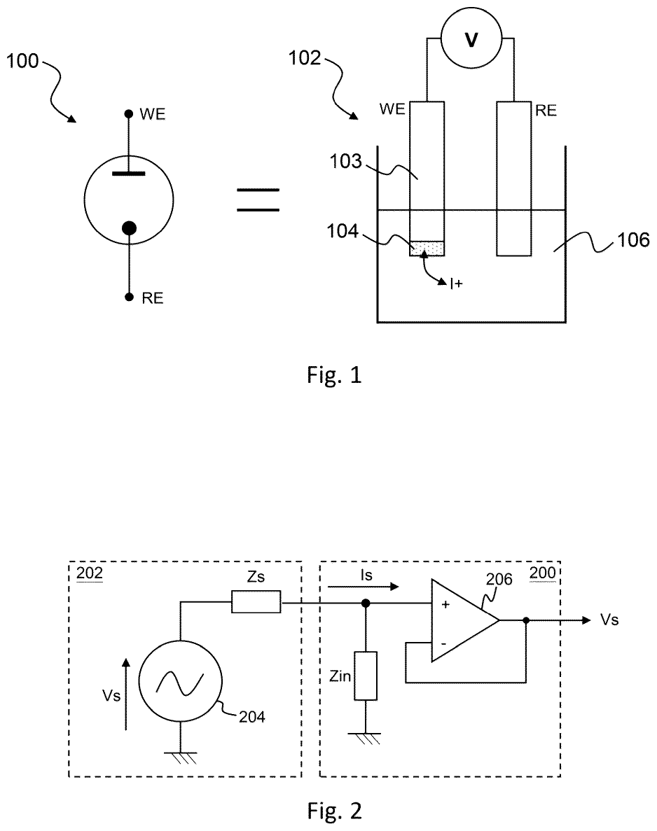

FIG. 1 illustrates an electrochemical cell 100 typically configured for potentiometric sensing alongside a schematic diagram of an example implementation of the electrochemical cell 100 as a potentiometric sensor. The cell 100 comprises a working electrode WE and a reference electrode RE. The working electrode WE comprises an ion-selective electrode 103 having an ion-selective membrane 104, which may be configured to uptake only a specific ion (in this case the cation, I+) from an electrolyte solution 106. As such, the potential difference between the working electrode WE and the reference electrode RE depends on the concentration of that particular ion analyte in the electrolyte solution 106.

To accurately measure the potential difference across the cell 100, as little as possible current (ideally no current) need flow into the cell 100. Hence, a typical approach to voltage measurement is to couple each of the working and reference electrodes WE, RE to high input impedance buffers which are used, in turn, to drive one or more ADCs (e.g. two single ended ADCs or one differential ADC). A digital output signal is then derived which represents the potential difference between working and reference electrode WE, RE of the cell 100.

FIG. 2 is a schematic diagram of a typical measurement circuit 400 for measuring a potential difference Vs across the two-electrode cell 100 implemented as a potentiometric sensor. An equivalent circuit model 202 for the cell 100 is shown in FIG. 2. The model comprises a voltage source 204 (generating the potential difference or sense voltage Vs) and a series impedance Zs. The voltage source 204 is coupled between a reference voltage (in this case ground) and the series impedance Zs which itself is coupled to an input of the measurement circuit 200. The measurement circuit 200 comprises a buffer amplifier 206 and an input impedance Zin. Anon-inverting input of the buffer amplifier 206 is coupled to the series impedance Zs of the cell 100. The input impedance Zin is coupled between the non-inverting input of the buffer amplifier 206 and a reference voltage (in this case ground). An inverting input and output of the buffer amplifier 206 are coupled together. Thus, the measurement circuit 200 is configured as a high input impedance buffer amplifier which buffers the sense voltage Vs across the cell 100 to the output of the measurement circuit 200.

The input impedance Zin of the measurement circuit 200 is typically an order of magnitude higher than the series impedance Zs of the cell 100. With electrochemical sensors typically having an impedance in the gigaohm range (e.g. 1-10 GΩ), this can lead to the measurement circuit 200 having an input impedance Zs in the order of teraohms (e.g. 1-10 TΩ). To operate at such high input impedance, the measurement circuit 200 is required to have low leakage to avoid drift in the sensed voltage Vs. Such operation can lead to high power consumption and large circuit area. In attempting to select an appropriate impedance level, the impedance needs to be high enough to receive a useful signal, but not so high that leakage and/or noise saturates the circuit front-end. Additionally, synthesizing the required input impedance Zin can require either active circuitry or complex process options which can lead to added cost and complexity. Despite such efforts, the circuit 200 tends to show undesirable temperature dependence.

Thus, there are several problems with the use of high input impedance measurement circuitry of potentiometric sensing:
1. Calibration: It is desirable to convert measured voltage into a concentration of an analyte present in the cell 100. However, the measured output voltage Vs is a sum of the voltage difference between the Reference Electrode (RE) and the Working Electrode (WE), both of which can evolve differently in time.
2. Selectivity: Selectivity describes how much of the sense voltage Vs is due to the ion of interest versus an interfering ion. For example, sodium (Na) and potassium (K) ions are relatively similar which can present selectivity challenges. Improved selectivity to just the ion of interest is desirable. Due to different diffusion time constants for each ion, the impedance of the cell 100 will respond differently at different frequencies.
3. Noise/Drift: A variety of noise sources exist, including drift, which lead to errors in measured DC voltage and hence inferred concentration levels. For example, low frequency noise (e.g. drift) which is due to 1/fn noise in the measurement circuitry and in the sensor/cell 100. Additionally, leakage currents can give rise to noise due to the high input impedance. Small leakage currents give rise to large voltages relative to the signal level. Sensitivity to leakage is a large problem for wearable sensors, as high moisture environments (e.g. when in a bath or shower) are a common use case. The high impedance of the sensor also causes coupling issues and common mode settling problems. Finally, Faradaic reactions in the ISE of the cell 100 can also lead to significant drift over time, as will be explained in more detail below.

In addition to leakage currents, the inventors have found that noise scales inversely with ion concentration in the cell 100. Conversely, signal to noise ratio (SNR) is proportional to ion concentration in the cell 100. Higher ion concentrations generally lead to improved SNR for two reasons. First, from the Nernst equation, it can be shown that the signal (e.g. Vs) increases as ion concentration increases. Second, as ion concentration increases, resistance of the ion-selective membrane (ISM) of the ISE decreases, leading to a decrease in relative noise.

The inventors have realized that by leveraging this relationship, an approximation of analyte concentration in the cell 100 can be obtained. In addition, such an approximation can be improved by measuring noise at one or more frequencies at which noise is dominated by noise associated with the ISE.

The signal-to-noise ratio (SNR) for an ion-selective electrode (ISE) can be calculated by considering the signal derived from the Nernst equation and the noise, which in this case is typically dominated by thermal (Brownian) noise. The Nernst equation provides the electromotive force (EMF) or potential E across the membrane as a function of ion concentration:

$$E = {E}^{0} + \frac{RT}{zF} ln ( \frac{[ ion ]}{[ {ion}_{in} ]} )$$

Where [ionᵢₙ] is the ion concentration inside the ISM (internal concentration) and [ion] is the concentration outside the ISM (external concentration).

The signal, S, is the potential difference derived from the Nernst equation, i.e.:

$$S = \frac{RT}{zF} ln ( \frac{[ ion ]}{[ {ion}_{in} ]} )$$

For simplicity, it may be assumed that internal concentration [ionᵢₙ] is constant, and we are primarily interested in how the signal changes with external concentration [ion]. The noise in an ISE, dominated by thermal noise (Brownian noise), is related to the resistance of the membrane and can be represented by the Johnson noise voltage:

$${V}_{noise} = \sqrt{4 {k}_{B} TR Δ f}$$

Where k_{B} is Boltzmann's constant, T is the temperature in Kelvin, and R is the resistance which depends on the ion concentration [ion] and Δf is the bandwidth of the measurement. The membrane resistance R is inversely proportional to the ion concentration [ion], thus:

$$R = \frac{{R}_{0}}{[ ion ]}$$

Where R₀ is a proportionality constant. Thus, the noise voltage can be expressed as:

$${V}_{noise} = \sqrt{4 {k}_{B} T \frac{{R}_{0}}{[ ion ]} Δ f}$$

The SNR is the ratio of the signal to the noise:

$$SNR = \frac{S}{{V}_{noise}}$$

Substituting the expressions for S and Vₙₒᵢₛₑ, the SNR can be expressed as:

$$SNR = \frac{\frac{RT}{zF} ln ( \frac{[ ion ]}{[ {ion}_{in} ]} )}{\sqrt{4 {k}_{B} T \frac{{R}_{0}}{[ ion ]} Δ f}}$$

The above equation can be simplifying to the following equation:

$$SNR = \frac{RT}{zF} \cdot \frac{ln ( \frac{[ ion ]}{[ {ion}_{in} ]} )}{\sqrt{4 {k}_{B} {TR}_{0} Δ f}} \cdot \sqrt{[ ion ]}$$

This expression shows that the SNR depends on the external ion concentration [ion] as well as the logarithm of the external ion concentration [ion]. In particular, at very low concentrations, the SNR becomes relatively very small since the logarithmic signal term in the above equation decreases, and the noise increases. In contrast, as the ion concentration increases, the SNR increases since the external ion concentration [ion] increases.

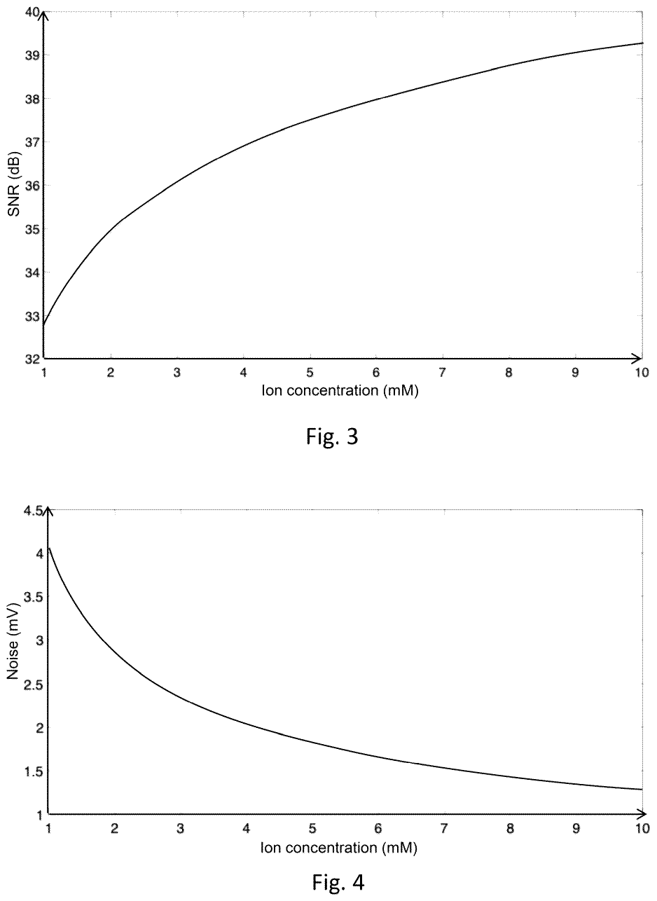

FIG. 3 graphically illustrates this relationship between ion concentration and SNR. FIG. 4 graphically illustrates the corresponding relationship between ion concentration and noise.

Thus, embodiments of the present disclosure leverage this relationship to determine characteristics of an electrochemical cell based on a measurement of noise (or SNR) in the cell 100.

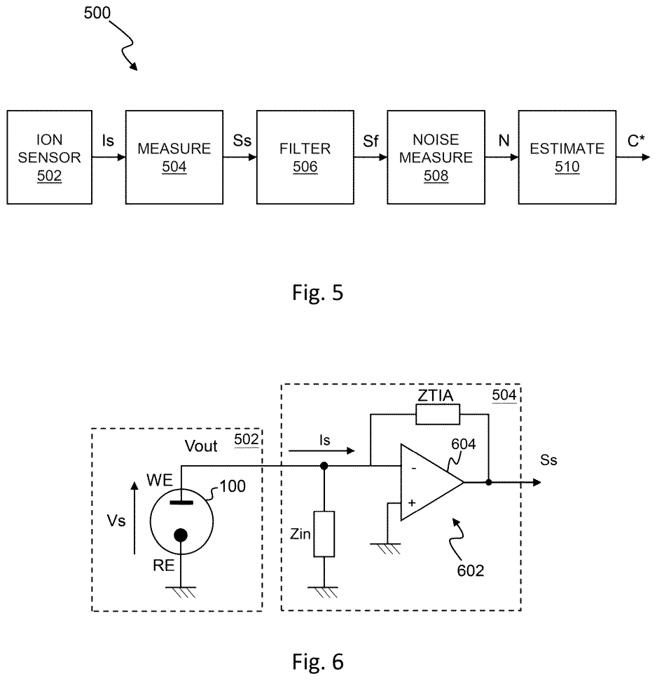

FIG. 5 is a schematic diagram of circuitry 500 for estimating a concentration of an analyte in an electrochemical cell, such as the cell 100 shown in FIG. 1. The electrochemical cell 100 may be provided in an ion-sensor 502. The circuitry 500 comprises measurement circuitry 504, a filter 506, noise estimation circuitry 508, and estimation circuitry 510.

The measurement circuitry 504 may be similar in form to the measurement circuit 200 shown in FIG. 2. The measurement circuit 200 is configured to convert a sense current Is or a sense voltage Vs at the ion sensor 502 to a sense signal Ss, the sense voltage Ss corresponding to a voltage Vs across the cell 100. The sense signal Ss is provided to the filter 506.

The filter 506 is configured to filter the sense signal Ss to obtain a filtered sense signal Sf. The filter 506 may be configured to pass frequencies of the sense signal Ss at which the behaviour of the ion-sensor 502 is dominated by the ISE 103 of the cell 100. In other words, the filter 506 may be configured to pass frequencies of the sense signal Ss at which noise varies the most with ion concentration. To achieve this, the filter 506 may comprise a bandpass filter or a lowpass filter. A bandpass filter may be centred on a frequency at which the behaviour of the ion-sensor 502 is dominated by the ISE 103 of the cell 100. The filter 506 may be configured to implement multiple bandpass filtered centred on multiple frequencies of interest, such frequencies at which the behaviour of the ion-sensor 502 is dominated by the ISE 103 of the cell 100. The filter 506 may be implemented as a lowpass filter, for example, if there is a frequency region below a certain frequency which is dominated by the ISE 103 of the cell 100. In which case, such a lowpass filter may have a cutoff frequency at that frequency below which behaviour of the ion sensor 502 is dominated by the ISE 103.

The filtered signal Sf is provided to the noise estimation circuitry 508. The noise estimation circuitry 508 may be configured to estimate one or more characteristics of noise of the filtered signal Sf. For example, to obtain a measure of noise in a signal, the standard deviation and mean of that signal may be estimated. As is known in the art, SNR may be calculated by dividing the mean of a signal by the standard deviation of that signal, i.e.:

$$SNR = \frac{μ}{σ}$$

Various methods are available to calculate standard deviation of a signal as well as variance, percentile, mean and median, as will be discussed below.

For example, estimating the standard deviation of the filtered signal Sf may be performed using statistical methods such as Student's t-test. In this approach, the filtered signal Sf is treated as a set of random variables with a certain distribution. To estimate the standard deviation, the sense signal Sf may optionally be converted into the digital domain, for example by an analog-to-digital converter (ADC) (not shown). A first sample of the filtered signal Sf may be obtained, and the mean of that sample calculated. The sample standard deviation may then be used as an estimate of the population standard deviation. If the sample size is small, the student's t-distribution can be applied instead of the normal distribution to account for the additional uncertainty. The students t-distribution adjusts for the sample size by providing a more conservative estimate of the standard deviation, particularly when the sample size is less than 30. To compute the students t-distribution, the sample variance may be calculated, divided by the square root of the sample size, and multiplied by a critical t-value, which is determined by the degree of freedom (sample size minus one) and the desired confidence level. This provides an interval within which the true standard deviation is likely to lie, helping to better estimate the uncertainty of the filtered signal Sf.

Various methods exist for computing mean and variance of a signal, such as the filtered signal Sf. Such methods include but are not limited to offline methods, such as the two-pass method, and the Naïve method, and online methods, such as Welford's method. In the present case, it may be beneficial to implement an online approach, such as Welford's method. An advantage of Welford's method for online processing is that both the mean and variance of the filtered signal Sf can be updated iteratively in a single pass. This is a particular advantage when computing mean and variance for large datasets, where numerical errors from processing large datasets can accumulate and distort results. Welford's approach is memory-efficient, as it does not require storing the entire dataset in memory. Instead, only a few variables are tracked, making it ideal for applications with limited memory or real-time data processing. Welford's method also works effectively for processing streaming data, allowing updates to mean and variance as new data points arrive.

An alternative online approach to Welford's method uses approximate forms of the percentile and median as estimates of noise. Such estimates are robust to outliers. The median and percentile of the filtered signal Sf may be approximated using the recursive forms of each.

For example, the median γ for a data set x can be approximated using the following equation:

$${γ}_{n + 1}^{*} = {γ}_{n}^{*} + λ \cdot sign \{ {x}_{n} - {γ}_{n}^{*} \}$$

Where sign is the sign (e.g. x>0 sign(x)=+1, x=0 sign(x)=0, x<0 sign(x)=−1).

The percentile q can be approximated using the following equation:

$${q}_{n + 1}^{*} = {q}_{n}^{*} + λ ( sign \{ {x}_{n} - {q}_{n}^{*} \} + 2 p - 1 )$$

Where γ is small, p is the percentile between 0 and 1 (e.g. p=0.5 approximates the median). To estimate the noise, the interquartile range (IQR) may be used. For a a typical (e.g. Gaussian) noise process, the relationship between the IQR and the standard deviation, σ, may be expressed through the properties of the normal distribution. The IQR is the difference between the 75^{th} percentile (Q3) and the 25^{th} percentile (Q1) in the normal distribution. This represents the range in which the middle 50% of data lies.

For a Gaussian distribution of noise, both quartiles are fixed distances from the mean. The 25th percentile corresponds to the value where 25% of the distribution is below it, which for a standard normal distribution (mean=0, std=1) is approximately −0.674 standard deviations from the mean. The 75th percentile corresponds to the value where 75% of the distribution is below it, which for a standard normal distribution is approximately +0.674 standard deviations from the mean. The IQR for a Gaussian distribution is roughly 1.349 times the standard deviation (a). This relationship is due to the difference between the z-scores at the 25th and 75th percentiles:

$$\begin{matrix}IQR = {θ}_{3} - {θ}_{1} \\ IQR = 0.674 -- 0.674 \\ IQR = 1.349\end{matrix}$$

$$σ = \frac{IQR}{1.349}$$

As such, the IQR for Gaussian noise 1.349 times the standard deviation. If the IQR is known, the standard deviation may be estimated using the following equation:

$$σ = \frac{IQR}{1.349}$$

Any one or more of mean, median, variance, percentiles, and standard deviation may be output by the noise estimation circuitry 508 as noise data N pertaining to noise in the filtered signal Sf. The noise data N is provided to the to the estimation circuitry 510.

The estimation circuitry 510 may be configured to estimate one or more characteristics of the cell 100 of the ion-sensor 502 in dependence on the noise data N. Such characteristics may comprise one or more of impedance, analyte concentration, and a condition (e.g. fault).

For example, ion concentration (and therefore analyte concentration) can be derived from SNR in the manner discussed above, using the following equation (also recited above):

$$SNR = \frac{RT}{zF} \cdot \frac{ln ( \frac{[ ion ]}{[ {ion}_{in} ]} )}{\sqrt{4 {k}_{B} {TR}_{0} Δ f}} \cdot \sqrt{[ ion ]}$$

To determine how the resistance R of the cell 100 varies with analyte concentration C one or more approximations may be used. For example, at low to moderate concentrations, the resistance R varies approximately inversely with concentration, q.v.:

$$R ( C ) \approx \frac{k}{{Λ}_{M}^{∘} C}$$

Where

$${Λ}_{M}^{∘}$$

is the molar conductivity at infinite dilution (or limiting molar conductivity), which can be determined by extrapolation of Λ_{M} as a function of √c, and k is the Kohlrausch coefficient which depends on ion type, temperature, solvent properties (e.g. dielectric constant), and viscosity.

The second order form of the above equation may be written as follows:

$$R ( C ) \approx \frac{k}{{Λ}_{M}^{∘} C - α {C}^{\frac{3}{2}}}$$

Where α is the dissociation degree of the electrolyte.

Thus, it will be appreciated that in certain conditions resistance R increases with analyte concentration C, whereas in other conditions resistance R decreases with analyte concentration C. Two requirements can be set taking into account the above equation.

The first requirement is that resistance R should increase with concentration C:

$$\frac{dR}{dC} > 0 , {C}_{min} = {( \frac{2 {Λ}_{M}}{3 α} )}^{2}$$

The second requirement is that resistance R should be positive:

$$R ( C ) > 0 , {C}_{min} = {( \frac{2 {Λ}_{M}^{∘}}{3 α} )}^{2}$$

Thus, the condition for which resistance R is positive and increases as a function of analyte concentration C corresponds to a non-ideal behaviour regime in the electrolyte solution. In this regime, electrostatic interactions and ionic shielding effects dominate, leading to reduced ion mobility. The electrolyte solution's overall ability to conduct electricity decreases with additional ions, despite an increase in ion concentration, due to the reduced effective conductivity. This behaviour reflects a transition from ideal conductivity (where an increase in ion concentration leads to an increase in conductivity) to a non-ideal regime where increased interactions reduce conductivity, leading to increased resistance R with concentration C. This transition between ideal and non-ideal conductivity range leads to an inversion in the relationship between impedance R and concentration C in the cell 100. This relationship may be determined for a given electrochemical cell, such as the cell 100 in a number of ways, including but not limited to modelling and/or offline calibration. In practice, such calibration may be performed for each sensor or batch of sensors being manufactured.

The estimation circuitry 510 may be configured to take all of the above factors into account when determining an estimate of impedance, resistance, analyte concentration or other characteristics of the cell 100 of ion-sensor 502.

As noted above, the measurement circuitry 504 may comprise the measurement circuit 200 shown in FIG. 2. Alternatively, the measurement circuitry 504 may comprise circuitry configured to establish on its first input X a voltage equal to the voltage provided to its second input Y. An example component which exhibits this characteristic includes a current conveyor (CC). A current conveyor (CC) is able to buffer an input current to its output Z whilst maintaining a voltage at its first input X equal to a voltage applied to its second input Y. Another example of a circuit element which exhibits such a characteristic is a transimpedance amplifier (TIA).

FIG. 6 is a schematic diagram of an example implementation of the ion-sensor 502 and the measurement circuitry 504.

In this example, the ion-sensor 502 comprises the electrochemical cell 100 shown in FIG. 1 comprising working and reference electrodes WE, RE.

In a variation of the arrangement shown in FIG. 4, the TIA 402 may be replaced with a current conveyor (CC). In which case, the sense signal Ss output from the current conveyor is a current.

In this example, the measurement circuitry 504 comprises a transimpedance amplifier (TIA) 602 comprising an operational amplifier 604, a feedback impedance ZTIA and an input impedance Zin. The operational amplifier 604 comprises a non-inverting input coupled to the working electrode WE of the cell 100, an inverting input coupled to a bias voltage (in this case ground GND), and an output. The feedback impedance ZTIA is coupled between the output and the inverting input of the operational amplifier 604. Thus, the TIA 602 is configured to output a voltage as the sense signal Ss which is proportional to the sense current Is at the working electrode WE.

In a variation of the arrangement shown in FIG. 6, the TIA 602 may be replaced with a current conveyor (CC). In which case, the sense signal Ss output from the current conveyor is a current.

Embodiments are described above with reference to the cell 100 comprising two electrodes (e.g. a working electrode WE and a reference electrode RE). Embodiments of the disclosure are not, however, limited to having cells having two electrodes. Any of the embodiments described herein may be modified for three electrode cells comprising a working electrode WE, counter electrode CE, and a reference electrode RE.

Additionally, the concepts described herein are particularly applicable to cells comprising multiple working electrodes or multiple counter electrodes. In doing so, such sensors may either providing redundancy or enabling the sensing of multiple analytes in a single chip. This may be particularly advantageous in applications such as continuous glucose monitoring, where it may be desirable to measure concentrations of several analytes including but not limited to two or more of glucose, ketones, oxygen, lactate, and the like. Moreover, the measurement circuits described herein may be configurable in different configurations for different types of measurements. Such measurements may be of the same or different cells or electrodes.

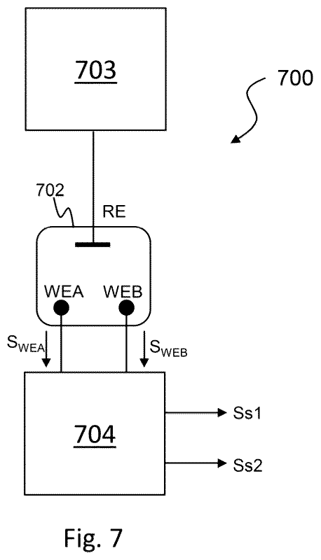

FIG. 7 illustrates an example circuit 700. In the circuit 700, an electrochemical cell 702 is shown comprising first and second working electrode WEA, WEB and a reference electrode RE. Each of the first and second working electrodes WEA, WEB may comprise an ISE. A drive circuit 703 is provided to apply a stimulus or DC bias to the reference electrode RE. The DC bias applied by the drive circuit 703 may be ground or 0V. A measurement circuit 704 is provided which is configured to output a first sense signal Ss1 based on a signal S_{WEA} derived from the first working electrode WEA and output a second sense signal Ss2 based on a signal S_{WEB} derived from the second working electrode WEB. The first and second sense signal Ss1, Ss2 may be in the digital or analog domain. The measurement circuit 704 may, for example, comprise two processing channels, each processing channel implementing the circuitry 500 described herein. Alternatively, various components of the circuitry 500 described herein may be shared between the two processing channels, e.g., through multiplexing or similar known techniques.

Embodiments of the present disclosure are described with reference to the example electrochemical cell 100. It will be appreciated, however, that the techniques and apparatus described herein may be used in conjunction with any conceivable electrochemical system, including but not limited to electrochemical cells comprising at least two electrodes (e.g. two or more of a counter electrode CE, a working electrode WE and a reference electrode RE), or electrochemical cells with more than three electrodes (e.g. two or more counter electrodes and/or two or more working electrodes). Electrodes of the electrochemical cells described herein may also be referred to as anodes and/or cathodes as is conventional in the field of electrical batteries.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote control device, a home automation controller or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. Circuitry for determining a characteristic of an electrochemical cell having a first electrode and a second electrode, the circuitry comprising:
measurement circuitry configured to measure a cell signal derived from the first electrode and output a sense signal at an output of the measurement circuitry based on the measured cell signal;
a filter configured to filter the sense signal to obtain a filtered sense signal; and
processing circuitry configured to:
estimate a signal noise level in the filtered sense signal; and
determine the characteristic of the electrochemical cell based on the signal noise level.

2. Circuitry of claim 1, wherein estimating the signal noise level comprises:
determining a standard deviation or variance of the filtered sense signal; and
determining a mean of the filtered sense signal.

3. Circuitry of claim 2, wherein the standard deviation or variance is determined using a Student's algorithm.

4. Circuitry of claim 2, wherein the mean and variance are determined using an online algorithm.

5. Circuitry of claim 4, wherein the online algorithm comprises Welford's algorithm.

6. Circuitry of claim 1, wherein estimating the signal noise level comprises one or more of:
determining a median of the filtered sense signal;
determining one or more percentiles of the filtered sense signal; and
determining an interquartile range based on the median and the one or more percentiles.

7. Circuitry of claim 1, wherein estimating the signal noise level comprises:
determining a signal to noise ratio (SNR) of the filtered sense signal.

8. Circuitry of claim 1, wherein the processing circuitry comprises an analog-to-digital converter, ADC, configured to output a digital sense signal based on the filtered sense signal, wherein the signal noise level is estimated based on the digital sense signal.

9. Circuitry of claim 1, wherein the filter is configured to pass one or more frequencies of interest of the sense signal at which variation in noise with varying analyte concentration in the electrochemical cell is maximised.

10. Circuitry of claim 1, wherein the first electrode is an ion selective electrode the filter is configured to pass one or more frequencies of interest at which a behaviour of the electrochemical cell is substantially dominated by the ion-selective electrode.

11. Circuitry of claim 9, wherein the filter comprises a bandpass filter centred on the one or more frequencies of interest.

12. Circuitry of claim 9, wherein the filter comprises a lowpass filter having a cutoff frequency at or above the one or more frequencies of interest.

13. Circuitry of claim 1, wherein the characteristics comprises one or more of:
an impedance; and
an analyte concentration or an analyte.

14. Circuitry of claim 13, wherein the processing circuitry is configured to determine the analyte concentration based on the impedance.

15. Circuitry of claim 14, wherein the analyte concentration C is determined from the impedance R based on the following equation:
$$R ( C ) \approx \frac{k}{{Λ}_{M}^{∘} C - α {C}^{\frac{3}{2}}}$$
where
$${Λ}_{M}^{∘}$$
is the molar conductivity at infinite dilution, and α is the dissociation degree of the analyte in the cell.

16. Circuitry of claim 1, wherein the measurement circuitry comprises a transimpedance amplifier, TIA, comprising:
an op-amp comprising an inverting input configured to receive the cell signal, a non-inverting input coupled to a first reference voltage, the output of the measurement circuit comprising an output of the op-amp; and
a feedback impedance coupled between the output and the first input.

17. Circuitry of claim 16, further comprising an input impedance coupled between the inverting input and a second reference voltage.

18. Circuitry of claim 1, wherein the measurement circuitry comprises a current conveyor, CC, comprising an X input and a Y input, wherein the X input of the CC is configured to receive the cell signal, wherein the output of the measurement circuitry is a Z output of the CC.

19. Circuitry of claim 1, wherein the measurement circuitry comprises an op-amp comprising an inverting input configured to receive the cell signal, a non-inverting input, and an output, the output coupled to the non-inverting input.

20. Circuitry of claim 19, further comprising an input impedance coupled between the non-inverting input and a reference voltage.

21. Circuitry of claim 1, wherein the first electrode or the second electrode comprises an ion-selective electrode.

22. Circuitry of claim 1, wherein the sense signal comprises a sense voltage or a sense current.

23. An electrochemical sensor, comprising:
the circuitry of claim 1; and
the electrochemical cell.

24. The electrochemical sensor of claim 23, wherein the first electrode is a working electrode, and the second electrode is a reference electrode.

25. The electrochemical sensor of claim 23, wherein the first electrode is an anode, and the second electrode is a cathode.

26. A multi-analyte sensor, comprising:
the circuitry of claim 1; and
the electrochemical cell, wherein the first electrode is a first ion selective electrode, the second electrode is a reference electrode, and the electrochemical cell further comprises a second ion selective electrode.

27. An electronic device, comprising the circuitry of claim 1, wherein the electronic device comprises one of an analyte monitoring device or an analyte sensing device, a battery, a battery monitoring device, a mobile computing device, a laptop computer, a tablet computer, a games console, a remote control device, a home automation controller or a domestic appliance, a toy, a robot, an audio player, a video player, or a mobile telephone, and a smartphone.

28. (canceled)

29. A method of determining a characteristic of an electrochemical cell having a first electrode and a second electrode, the method comprising:
measuring a cell signal derived from the first electrode and output a sense signal at an output of the measurement circuitry based on the measured cell signal;
filtering the sense signal to obtain a filtered sense signal;
estimate a signal noise level in the filtered sense signal; and
determine the characteristic of the electrochemical cell based on the signal noise level.
